(19) United States
(12) Patent Application Publication
(10) Pub. No.: US 2026/0339988 A1
(43) Pub. Date: Oct. 29, 2026

(54) MANAGING EXPLAINABILITY OF RETRIEVAL-AUGMENTED GENERATION (RAG) PROCESSES USING DATA SOURCE CLUSTERING

(71) Applicant: Dell Products L.P., Round Rock, TX (US)

(72) Inventors: OFIR EZRIELEV, Be'er Sheva (IL); HANNA YEHUDA, Acton, MA (US); ANNE-MARIE MCREYNOLDS, San Jose, CA (US)

(21) Appl. No.: 19/191,431

(22) Filed: Apr. 28, 2025

(51) Int. Cl. G06F 16/3329; G06F 16/353; G06F 40/35

(52) U.S. Cl. CPC G06F 16/3329; G06F 16/353; G06F 40/35

(57) ABSTRACT

Methods and systems for providing computer-implemented services using generative AI models are disclosed. To do so, a prompt may be obtained for a first generative AI model of the generative AI models. A data source filtering process may be performed to obtain a sub-set of the data sources based, at least in part, on consistency of information content between clusters of data sources. The clusters may be assigned based on affiliations of the data sources. The prompt, the first generative AI model, and the sub-set of the data sources may be used to perform a retrieval-augmented generation (RAG) explainability process to obtain a plurality of outputs based on the prompt, perturbations of portions of the sub-set of the data sources, and a RAG explainability report. Computer-implemented services may be provided to a downstream consumer using at least the plurality of the outputs and the RAG explainability report.

### FIELD

Embodiments disclosed herein relate generally to providing computer-implemented services using generative artificial intelligence (AI) models. More particularly, embodiments disclosed herein relate to managing explainability of RAG processes using the generative AI models and data source clustering.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show flow diagrams illustrating data flows in accordance with an embodiment.

FIGS. 2D-2E show examples of clusters of data sources and consensus answers based on the clusters of the data sources in accordance with an embodiment.

FIGS. 2F-2I show examples of data used to perform portions of output explainability processes in accordance with an embodiment.

FIGS. 3A-3C show flow diagrams illustrating a method for providing computer-implemented services using generative AI models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using generative AI models. The generative AI models may include large language models (LLMs) that may generate outputs when provided with prompts. To generate the outputs, retrieval-augmented generation (RAG) processes may be performed (e.g., information may be retrieved from various data sources and used as context during output generation by the generative AI models). The outputs may be used, at least in part, to provide the computer-implemented services. For example, the outputs may be provided to a downstream consumer and the downstream consumer may use the outputs to make decisions. The RAG processes may improve a quality of the outputs (e.g., the outputs may be more likely to be based on relevant, up-to-date, and/or reliable contextual information).

However, a usefulness of the outputs to the downstream consumer may be reduced if the downstream consumer does not know why a particular output was generated. For example, a downstream consumer (e.g., a client, a customer) may desire to use an output to manage a computer system. However, if the LLM does not operate as expected (e.g., due to unreliable and/or otherwise undesired data sources being used as context to augment the prompt), the output may negatively impact the computer system. In addition, the computer system managed by the client may store private medical information, private financial information, and/or other data protected by various regulatory standards (e.g., general data protection regulation (GDPR), health insurance portability and accountability act (HIPPA)). The client may choose not to utilize the output generated by the LLM if the client is unable to determine whether the output generation process complies with one or more regulatory standards.

To increase a likelihood of outputs generated by generative AI models meeting expectations of downstream consumers, RAG explainability reports for outputs may be provided along with the outputs to downstream consumers. RAG explainability reports may provide downstream consumers with insight into a generative AI model's decision making processes and may allow the downstream consumer to make adjustments to the prompt and/or the available data sources to alter a particular portion of the output.

Prior to generating the RAG explainability report, a data source filtering process may be performed to identify a sub-set of the data sources based on: (i) relevance of information content of the data sources to the prompt, and (ii) inter-data source consistency of the information content of the data sources. To evaluate the inter-data source consistency, a clustering process may be performed for the data sources to obtain a set of clusters. Each cluster may include at least one data source and may be based on affiliations of the data sources (e.g., a political party, a company). Consistency of information content may be evaluated between clusters rather than between all of the data sources thereby reducing an influence of a particular affiliation on the majority consensus for information content. By doing so, a likelihood that data sources used during the RAG processes may include information content that is relevant to the prompt and not biased towards a particular affiliation may be increased.

To obtain the RAG explainability report, a RAG explainability process may be performed. During the RAG explainability process, members of the sub-set of the data sources may be iteratively perturbated to obtain perturbated sets of data sources. The prompt may be evaluated using the perturbated sets of data sources as context for the prompt using a generative AI model to obtain a plurality of outputs.

Information content of the plurality of the outputs may be compared to obtain differences (e.g., between iterative pairs of the plurality of the outputs). Relationships between members of the sub-set of the data sources and information elements of the plurality of the outputs may be established based on the differences and the relationships may be used to populate the RAG explainability report.

Thus, embodiments disclosed herein may provide an improved method for providing computer-implemented services using generative AI models. To provide the computer-implemented services as desired by downstream consumers, RAG explainability reports may be provided to the downstream consumers along with outputs generated by the generative AI models. The RAG explainability reports may explain which data sources have relationships to portions of the outputs, thereby increasing a usefulness of the outputs to the downstream consumer.

In an embodiment, a method for providing computer-implemented services using generative AI models is provided. The method may include: obtaining a prompt for a first generative AI model of the generative AI models; performing, using at least the prompt, the first generative AI model, and data sources, a data source filtering process to obtain a sub-set of the data sources, the sub-set of the data sources being based on: relevance of information content of the data sources to the prompt, and inter-data source consistency of the information content of the data sources, the inter-data source consistency being evaluated between clusters of the data sources and the clusters being assigned using a data source equivalence schema so that data sources with a same affiliation are assigned to a same cluster of the clusters; performing, using at least the prompt, the first generative AI model, and the sub-set of the data sources, a retrieval-augmentation generation (RAG) explainability process to obtain: a plurality of outputs based on the prompt and perturbations of members of the sub-set of the data sources, and a RAG explainability report indicating relationships between the members of the sub-set of the data sources and information elements of the plurality of the outputs; and providing computer-implemented services to a downstream consumer using at least the plurality of the outputs and the RAG explainability report.

Performing the data source filtering process may include: obtaining, based on the prompt, relevance criteria, and the data source equivalence schema, the clusters; generating, using a second generative AI model of the generative AI models and the prompt, a set of questions intended to elicit answers that have a pre-determined level of complexity; obtaining, using the set of the questions and the clusters, a set of answers to the set of the questions; and identifying, using at least a consensus threshold and the set of the answers, the sub-set of the data sources, the sub-set of the data sources corresponding to answers of the set of the answers that meet the consensus threshold.

Obtaining the clusters may include: obtaining, based on the prompt and the relevance criteria, a set of the data sources that comprises information content relevant to the prompt; obtaining, based on the data source equivalence schema and the set of the data sources, affiliations for the set of the data sources; and performing, based on the affiliations and the data source equivalence schema, a clustering process to obtain the clusters, each cluster of the clusters being associated with an affiliation of the affiliations.

The affiliations may include at least one type of affiliation selected from a list of types of affiliations consisting of: a political party affiliation; a company affiliation; a government entity affiliation; and an organization affiliation.

The pre-determined level of complexity may be a one-term answer.

Obtaining the set of the answers may include: obtaining, for each cluster of the clusters and based on the information content of the data sources, a consensus answer to each question of the set of the questions to obtain a set of consensus answers; and using the set of the consensus answers as the set of the answers.

Identifying the sub-set of the data sources may include: identifying, using the set of the answers, a frequency for each answer of the set of the answers to obtain a set of frequencies; selecting, based on the set of the frequencies and the consensus threshold, at least one consensus answer of the set of the answers that meets the consensus threshold; and rejecting data sources of the set of the data sources that provided answers to the set of the questions that do not match the at least one consensus answer for inclusion in the sub-set of the data sources.

Performing the RAG explainability process may include: iteratively perturbating members of the sub-set of the data sources to obtain perturbated sets of the data sources; evaluating the prompt using the first generative AI model and the perturbated sets of the data sources as context for the prompt to obtain perturbated outputs as the plurality of the outputs; obtaining, using a first output of the plurality of the outputs and a second output of the plurality of the outputs, first information elements of the first output and second information elements of the second output; comparing the first information elements and the second information elements to obtain a difference; and populating, based on the difference, the RAG explainability report with at least a first relationship of the relationships.

Iteratively perturbating the members of the sub-set of the data sources may include: performing at least one action selected from a list of actions consisting of: removing a first data source of the sub-set of the data sources to obtain a first perturbated set of the perturbated sets of the data sources; and replacing the first data source with a replacement data source to obtain the first perturbated set of the perturbated sets of the data sources.

Comparing the first information elements and the second information elements may include: obtaining first graph data structures of the first output, the first graph data structures comprising: a first set of nodes that correspond to the first information elements, and first edges that represent relationships between the first set of the nodes; obtaining second graph data structures of the second output, the second graph data structures comprising: a second set of nodes that correspond to the second information elements, and second edges that represent relationships between the second set of the nodes; and identifying, using the first graph data structures and the second graph data structures, one or more nodes of the second set of the nodes that is not present in the first set of the nodes.

A first graphical representation based on the first graph data structures and a second graphical representation based on the second graph data structures may be displayed to the downstream consumer via a graphical user interface (GUI).

The first generative AI model may be a large language model (LLM).

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

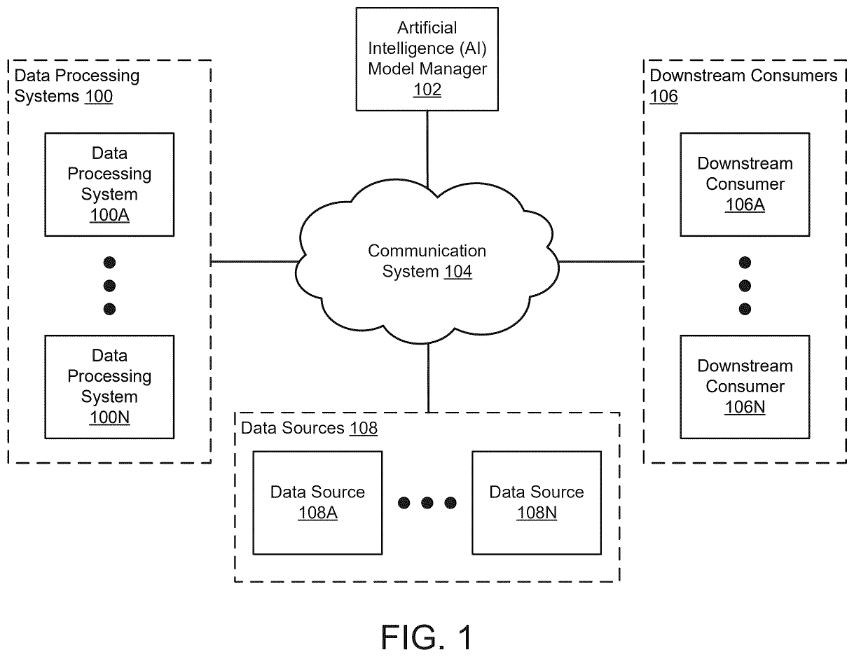

Turning to FIG. 1, a block diagram illustrating a system in accordance with an embodiment is shown. The system shown in FIG. 1 may provide for management of data processing systems that may provide, at least in part, computer-implemented services (e.g., to users of the system and/or devices operably connected to the system).

The computer-implemented services may include any type and quantity of computer-implemented services. The computer-implemented services may include, for example, database services, data processing services, electronic communication services, inference generation services, and/or any other services that may be provided using one or more computing devices. The computer-implemented services may be provided by, for example, data processing systems 100, AI model manager 102, downstream consumers 106, data sources 108, and/or any other type of devices (not shown in FIG. 1). Other types of computer-implemented services may be provided by the system shown in FIG. 1 without departing from embodiments disclosed herein.

The computer-implemented services may be provided, at least in part, using generative AI models and/or outputs obtained using the generative AI models. To do so, data processing systems 100 and/or AI model manager 102 may host any number of generative AI models.

To obtain the outputs, the generative AI models may be trained, using training data, to generate the outputs when provided with prompts (e.g., ingest data). The generative AI models may include large language models (LLMs) and, therefore, the outputs may include new instances of data created by the generative AI models based on learned associations from and/or an understanding of the training data. For example, the generative AI models may be trained using unstructured data, such as stories, essays, audio transcription, video description, and/or other types of human interpretable text, to generate outputs of the same. The outputs may be provided to downstream consumers 106 (e.g., client devices, data processing systems that manage computer systems and/or production systems) as part of providing the computer-implemented services.

However, a quality of the outputs (e.g., inferences) generated by the generative AI models may be impacted by a quality of the training data used to train the generative AI models. For example, if a generative AI model of the generative AI models is trained using training data that is: (i) unreliable, (ii) out-of-date, (iii) fabricated, (iv) not relevant to a desired application, and/or (v) otherwise of a quality that does not meet expectations of a downstream consumer, outputs generated by the generative AI model may not meet expectations of the downstream consumer.

To increase a likelihood that the outputs meet the expectations of the downstream consumer, ingest data packages may be obtained for the generative AI models. The ingest data packages may include the prompt and at least one data source to be used as context during output generation by a generative AI model (e.g., a RAG process). The at least one data source may be selected due to an information content of the data source being considered reliable, up-to-date, relevant to the prompt, and/or otherwise meeting criteria for the downstream consumer.

By doing so, the generative AI models may utilize data from the selected data source as context while generating an output based on a prompt. Consequently, a quality of the output may be more likely to meet expectations of the downstream consumer and a quality of computer-implemented services based on the output may be increased.

However, outputs may be provided to downstream consumers 106 as part of: (i) customer service requests (e.g., troubleshooting computer systems), (ii) data management processes (e.g., healthcare data, financial data), (iii) production system management processes (e.g., industrial applications), and/or (iv) other processes. The outputs, therefore, may be desired (e.g., by downstream consumers 106) to meet certain expectations. For example, downstream consumers 106 may expect the generative AI model and the outputs to comply with data privacy regulations (e.g., GDPR, HIPPA), may desire to mitigate unintended bias in outputs (e.g., when using the responses to make decisions based on financial data of consumers), and/or may otherwise wish to understand, audit, and/or modify operation of the generative AI models. If downstream consumers 106 are unable to determine whether the generative AI models and/or the outputs meet their expectations, a usefulness of the outputs to downstream consumers 106 may be reduced.

In general, embodiments disclosed herein may provide methods, systems, and/or devices for providing RAG explainability reports to downstream consumers along with the outputs generated by the generative AI models. The RAG explainability reports may describe (e.g., in human-interpretable text) why the generative AI model generated an output (e.g., may indicate relationships between data sources utilized as part of the RAG processes and portions of the output).

To do so, a prompt for a first generative AI model of the generative AI models and a sub-set of data sources may be obtained. The sub-set of the data sources may include information content that is deemed: (i) relevant to the prompt, and (ii) internally consistent (e.g., data sources of the sub-set of the data sources may include consistent information content). The sub-set of the data sources may be used, during a RAG process, to obtain context for the prompt and to obtain outputs from the first generative AI model based on the prompts and the context.

To obtain the sub-set of the data sources, a data source filtering process may be performed. During the data source filtering process, a set of data sources relevant to the prompt may be identified (e.g., using relevance criteria). The set of the data sources may be further refined (e.g., filtered) to obtain the sub-set of the data sources.

For example, the prompt and a second generative AI model of the generative AI models may be used to obtain a set of questions intended to elicit answers that have a pre-determined level of complexity (e.g., a one-term answer).

A clustering process may be performed, using a data source equivalence schema and the set of the data sources, to obtain clusters based on data source affiliations. For example, the set of the data sources may include ten data sources. Three of the ten data sources may be affiliated with a political party. The three data sources affiliated with the political party, therefore, may be assigned to a first cluster of the clusters. By clustering the data sources based on affiliations, entities associated with a particular affiliation may be less likely to influence RAG processes by generating a large number of data sources that support the particular affiliation.

The set of questions may be used to obtain a set of answers from the clusters. To do so, each cluster of the clusters may contribute one answer to each question of the set of the questions. The set of the answers may be evaluated, using a consensus threshold, to identify one or more consensus answers (e.g., an answer provided by at least 50% of the clusters). Data sources assigned to clusters that did not provide the one or more consensus answers may be rejected for inclusion in the sub-set of the data sources. By doing so, a likelihood that the sub-set of the data sources includes information that is relevant, reliable, up-to-date, and/or otherwise meeting expectations of a downstream consumer may be increased.

A RAG explainability process may be performed using the sub-set of the data sources and the prompt to obtain a plurality of outputs. The plurality of the outputs may be based on the prompt and perturbations of members of the sub-set of the data sources (e.g., each output of the plurality of the outputs may be based on a different perturbed set of the sub-set of the data sources and/or a subset of the clusters). For example, a plurality of ingest data packages may be obtained and each ingest data package of the plurality of the ingest data packages may include the prompt and a different perturbation of the sub-set of the data sources.

A RAG explainability report may be obtained using at least the prompt, the plurality of the outputs, the perturbations of the members of the sub-set of the data sources, and the first generative AI model. The RAG explainability report may indicate relationships between members of the sub-set of the data sources and information elements of the plurality of the outputs. Obtaining the RAG explainability report may include: (i) comparing iterative pairs of the plurality of outputs to obtain differences, (ii) establishing the relationships based on the differences, (iii) populating the RAG explainability report using the relationships, and/or (iv) other methods.

Thus, embodiments disclosed herein may improve processes of explaining outputs generated by generative AI models to downstream consumers of the outputs. By iteratively perturbating members of the sub-set of the data sources to obtain perturbated sets of data sources and comparing the outputs generated using the perturbated sets of the data sources, portions of the output may be associated with members of the sub-set of the data sources so that transparency of decision-making by the generative AI model to the downstream consumers may be increased.

To provide the above noted functionality, the system of FIG. 1 may include data processing systems 100, AI model manager 102, downstream consumers 106, data sources 108, and communication system 104. Each of these components is discussed below.

Data processing systems 100 may provide all, or a portion of, the computer-implemented services. Data processing systems 100 may include any number of data processing systems (e.g., 100A-100N) that may provide output generation services to downstream consumers 106. For example, a downstream consumer (e.g., 106A) may subscribe to output generation services provided by data processing system 100A and downstream consumer 106A may provide prompts (e.g., from clients, from owners of downstream consumer 106A, from employees of a company that owns downstream consumer 106A) to data processing system 100A as part of the subscribed services.

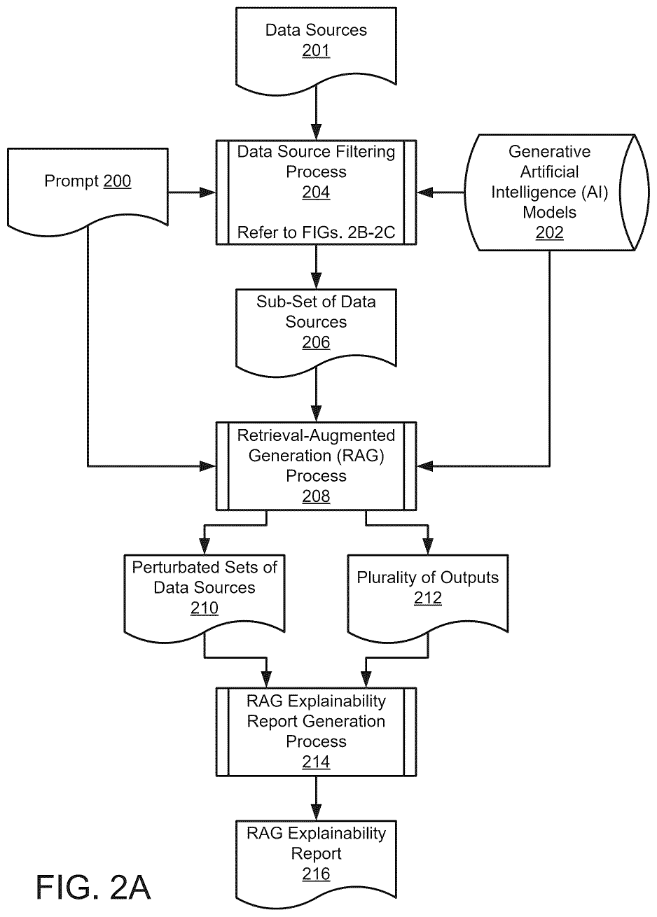

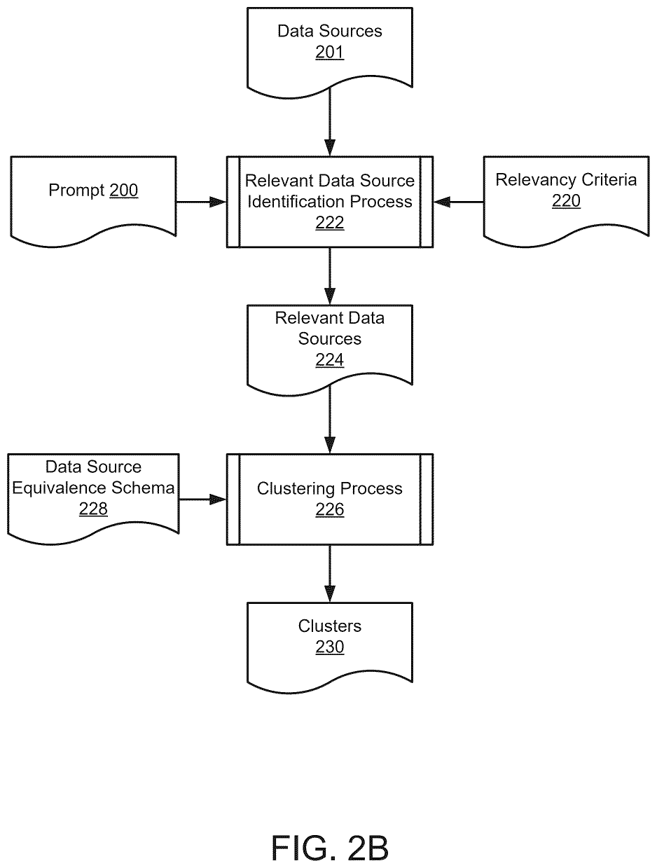

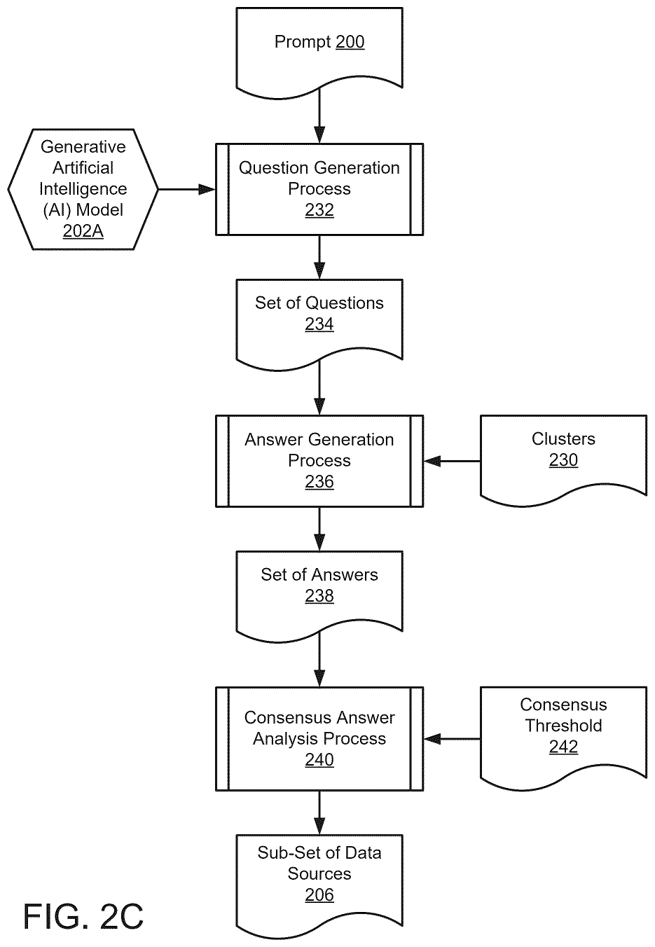

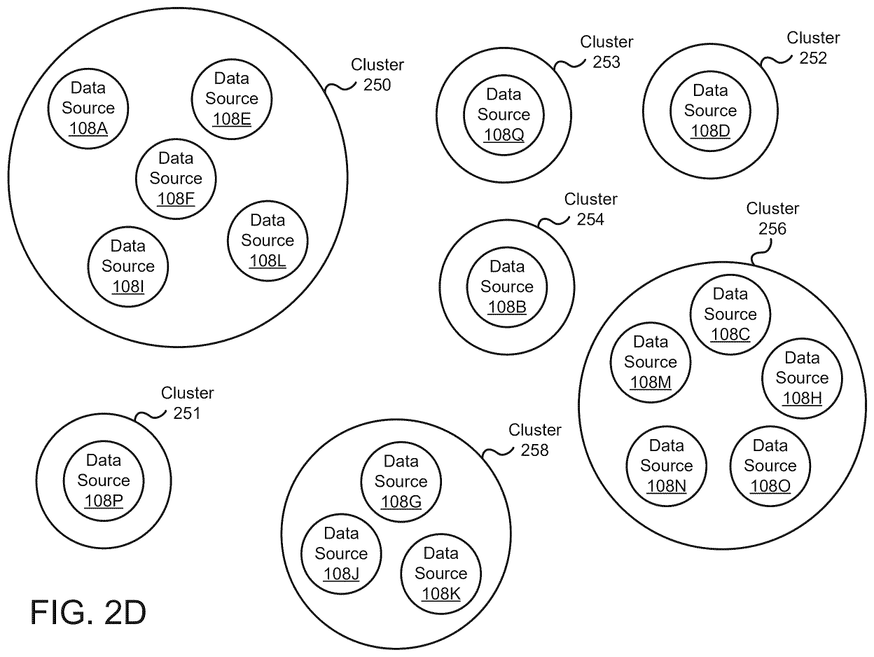

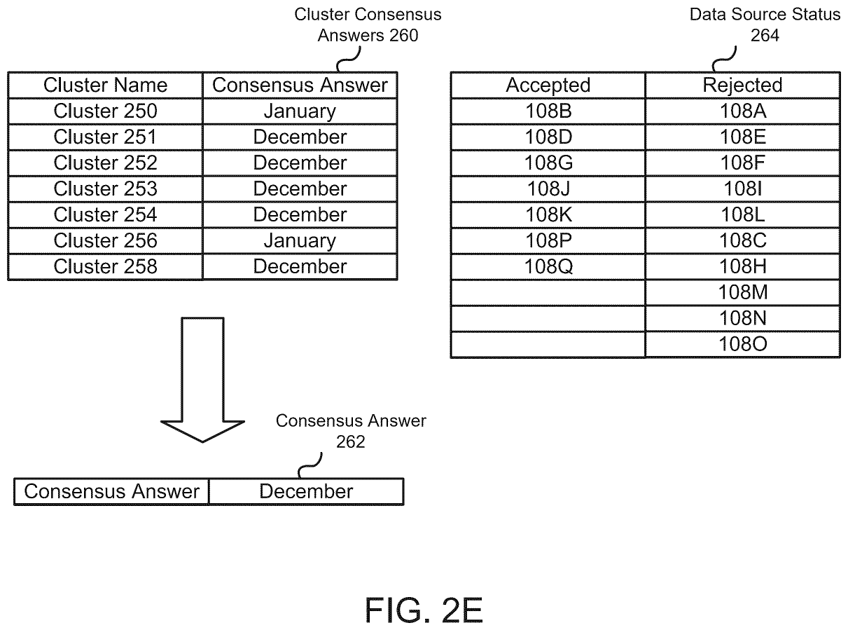

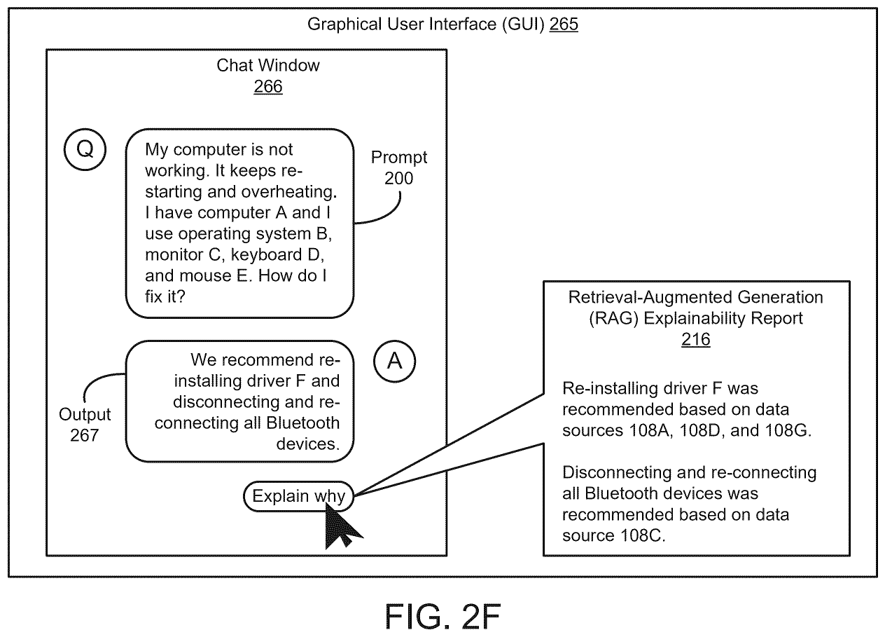

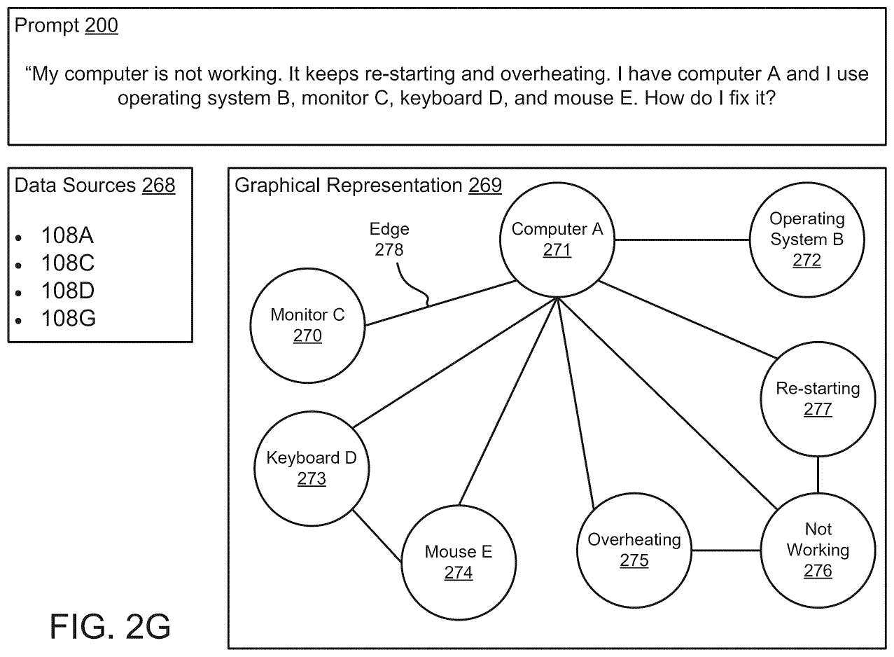

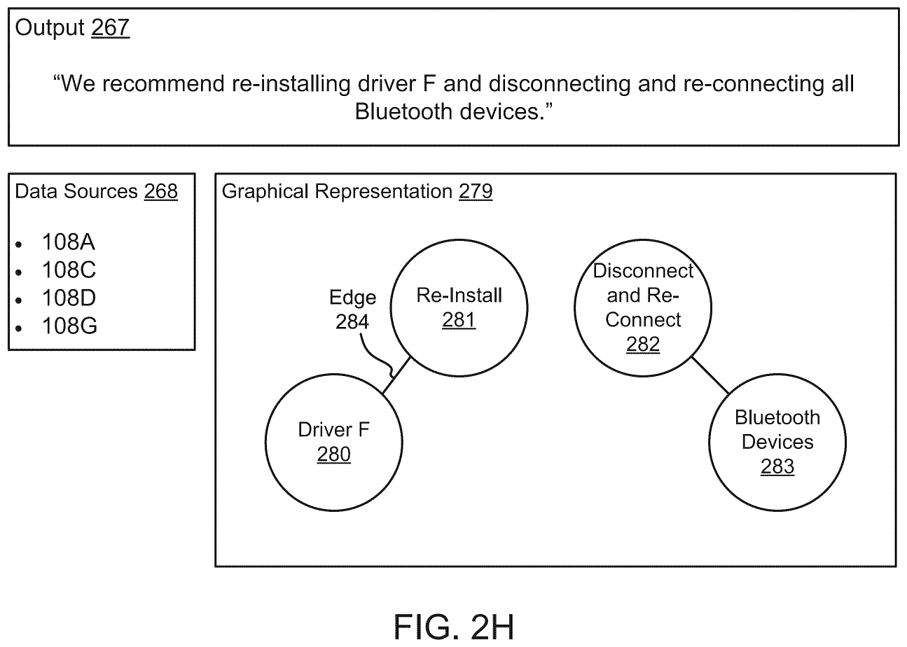

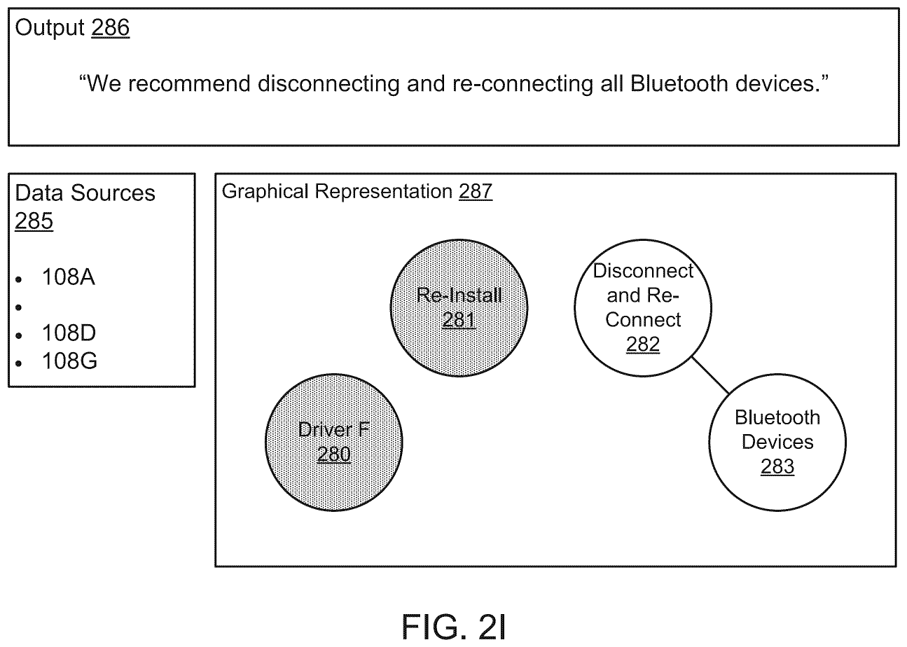

To provide computer-implemented services, data processing systems 100 may: (i) obtain prompts for generative AI models (e.g., hosted and/or operated by data processing systems 100), (ii) perform data source filtering processes to obtain sub-sets of the data sources that are to be used for RAG processes, (iii) perform RAG processes to obtain ingest data packages, outputs generated using the ingest data packages and generative AI models, and RAG explainability reports, (iv) provide computer-implemented services to downstream consumers 106 using at least the outputs and the RAG explainability reports, and/or (v) perform other actions. Refer to FIGS. 2B-2C for additional details regarding performing data source filtering processes. Refer to FIG. 2A for additional details regarding performing RAG explainability processes.

Data sources 108 may include any type and/or number of data sources (e.g., 108A, 108N). Each data source of data sources 108 may include hardware and/or software components configured to obtain data, store data, provide data to other entities, and/or to perform any other task to facilitate provision of the computer-implemented services. All, or a portion, of data sources 108 may provide (and/or participate in and/or support the) computer-implemented services to various devices operably connected to data sources 108. Different data sources may provide similar and/or different computer-implemented services.

For example, data sources 108 may be used to obtain (i) training data usable to train generative AI models, (ii) ingest data usable to prompt generative AI models to generate an output, (iii) contextual data for use during RAG processes, and/or (iv) other data. Data sources 108 may include data repositories (e.g., training data repositories), and may provide data to (e.g., allow access to data by) AI model manager 102 and/or data processing systems 100 (e.g., to perform data source analysis processes, to perform RAG processes).

AI model manager 102 may manage any number of AI models. For example, AI model manager 102 may: (i) obtain training data for AI models, (ii) train any number of AI models to obtain trained AI models, (iii) deploy trained AI models to other entities (e.g., data processing systems 100), (iv) update and/or modify trained AI models (e.g., fine-tune trained AI models based on additional training and/or production data), and/or (v) provide other AI model management services.

For example, AI model manager 102 may cooperatively provide at least a portion of the computer-implemented services to data processing systems 100 by: (i) obtaining training data from downstream consumers 106, (ii) training one or more AI models (e.g., generative AI models) using at least the training data obtained from downstream consumers 106 to obtain one or more trained AI models, (iii) deploying the one or more trained AI models to data processing systems 100 for use in providing output generation services for downstream consumers 106, and/or (iv) performing other actions.

Downstream consumers 106 may provide and/or consume all, or a portion of, the computer-implemented services. Downstream consumers 106 may include any number of downstream consumers (e.g., 106A-106N) and may include, for example, businesses, individuals, and/or devices (e.g., data processing systems) that may obtain outputs and/or other information based on the outputs (e.g., RAG explainability reports) as part of receiving the computer-implemented services.

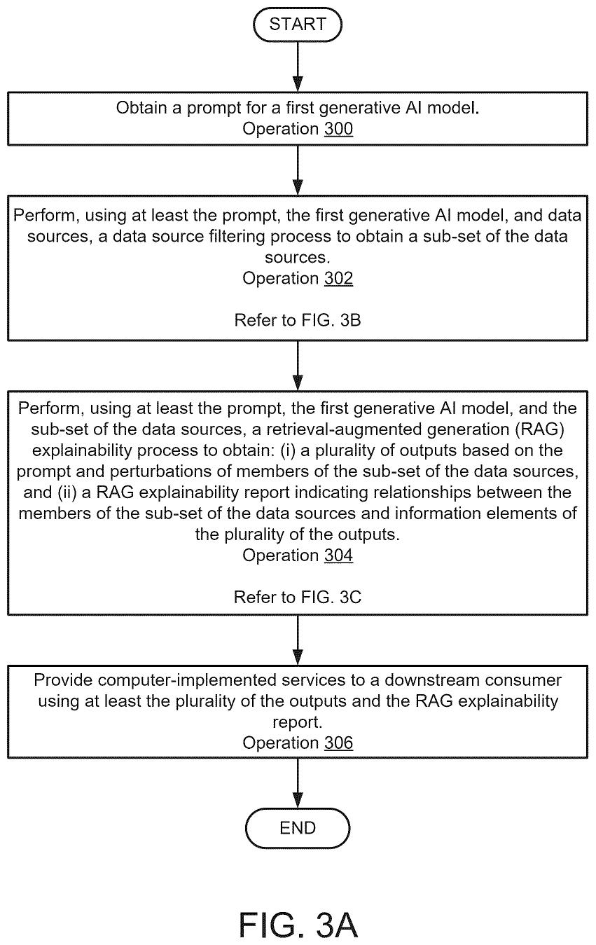

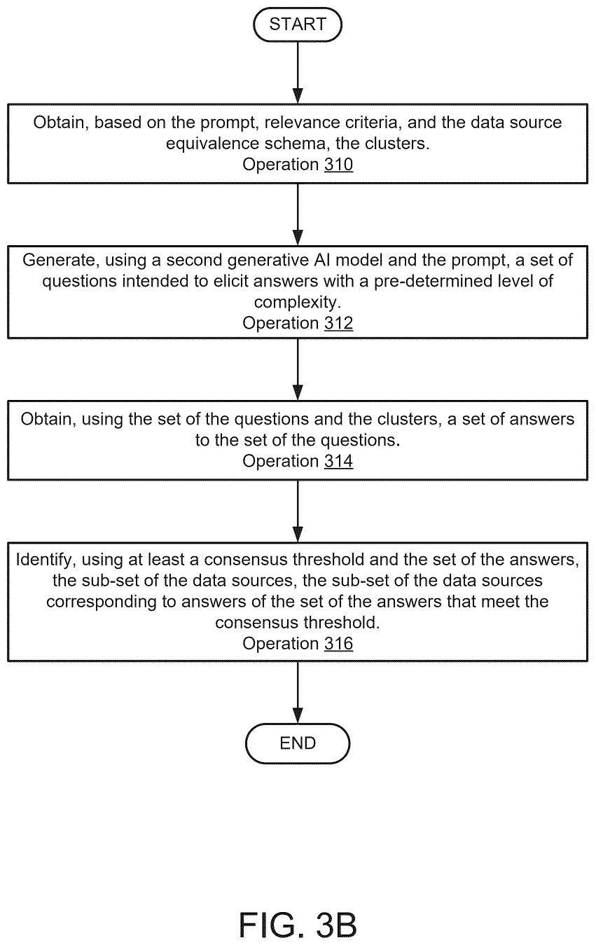

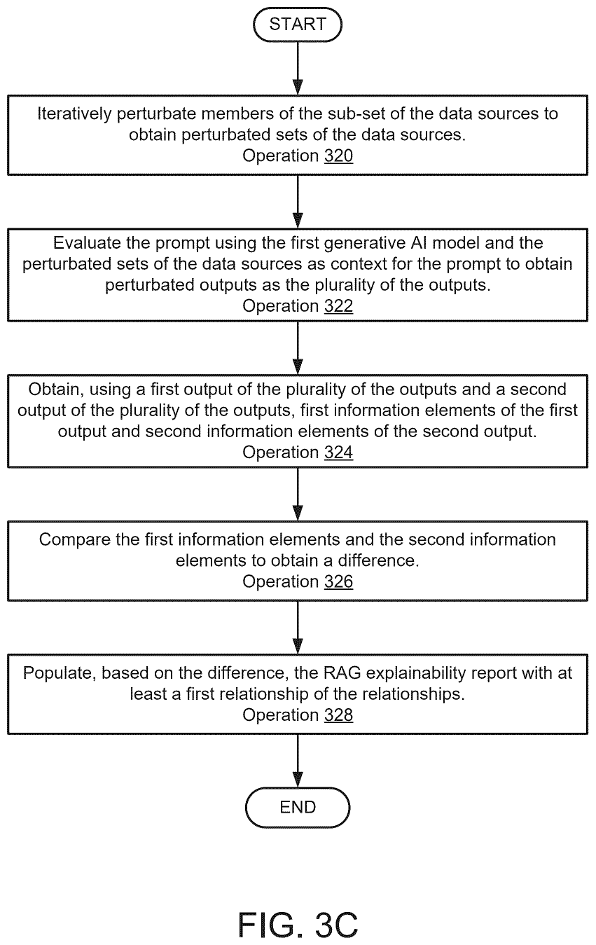

When providing their functionality, any of (and/or components thereof) data processing systems 100, AI model manager 102, data sources 108, and/or downstream consumers 106 may perform all, or a portion, of the actions and methods illustrated in FIGS. 2A-3C.

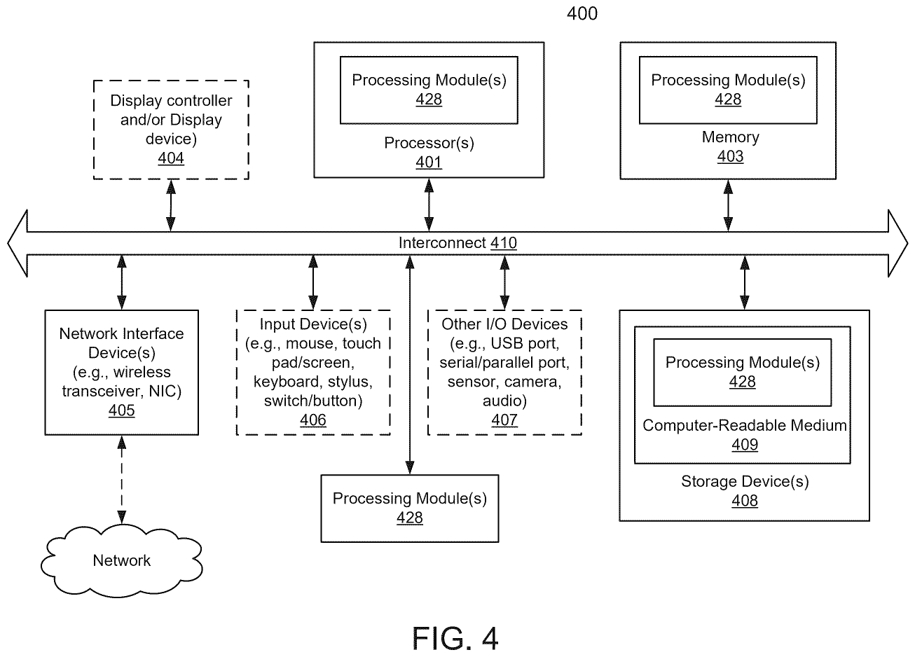

Any of (and/or components thereof) data processing systems 100, AI model manager 102, data sources 108, and downstream consumers 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

Communication system 104 may allow any of data processing systems 100, AI model manager 102, data sources 108, and downstream consumers 106 to communicate with one another (and/or with other devices not illustrated in FIG. 1). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to AI model manager 102 and downstream consumers 106 via the Internet. Data processing systems 100, AI model manager 102, downstream consumers 106, data sources 108, and/or communication system 104 may be adapted to perform one or more protocols for communicating via communication system 104.

While illustrated in FIG. 1 as including a limited number of specific components, a system in accordance with an embodiment may include fewer, additional, and/or different components than those illustrated therein.

While providing their functionality, any of data processing systems 100, AI model manager 102, data sources 108, and/or downstream consumers 106 may provide all or a portion of the methods shown in FIGS. 2A-3C.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 201, etc.) is used to represent data structures, a second set of shapes (e.g., 204, 208 etc.) is used to represent processes performed using and/or that generate data, a third set of shapes (e.g., 202) is used to represent large scale data structures such as databases, and/or other types of models, and a fourth set of shapes (e.g., 202A) is used to represent generative AI models.

Turning to FIG. 2A, a first data flow diagram in accordance with an embodiment is shown. The first data flow diagram may illustrate data used in and data processing performed in obtaining a plurality of generative AI model outputs and a RAG explainability report for the plurality of the outputs.

To obtain the plurality of the outputs and the RAG explainability report for the outputs, data source filtering process 204, RAG process 208, and RAG explainability report generation process 214 may be performed.

During data source filtering process 204, at least prompt 200, data sources 201, and generative AI models 202 may be used to obtain sub-set of data sources 206. Generative AI models 202 may include a database of generative AI models. The database may include data structures corresponding to any number of generative AI models (e.g., a list of identifiers for generative AI models, metadata regarding training of trained generative AI models).

For example, generative AI models 202 may include a first generative AI model (e.g., generative AI model 202A shown in FIG. 2B) and a second generative AI model (not shown). The data structures stored in generative AI models 202 may include: (i) information about architectures of the first and second generative AI models (e.g., a number of nodes, a number of edges), (ii) functions and/or numerical values (e.g., weights, biases, activation functions), and/or (iii) other information regarding the first and second generative AI models (e.g., identifiers, information about training data used to train the first and second generative AI models).

The generative AI models of generative AI models 202 may include LLMs (e.g., neural network inference models) trained to generate language, understand language, and/or otherwise process requests related to languages. The generative AI models may have been previously trained using training data and any training process (e.g., a global optimization process using gradient descent), the training data indicating goals for outputs generated by the generative AI models (e.g., outputs). Parameters of the generative AI models may be selected using an optimization process (e.g., an objective function may be defined in terms of the training data and outputs generated by the generative AI models, and a global optimization method such as gradient descent may be used to identify parameters that most faithfully reproduce the trends in the training data). Once the parameters of the generative AI models are set, then the generative AI models may be used to generate outputs (e.g., responses) based on input data (e.g., prompts). The generative AI models may be trained using other methods without departing from embodiments disclosed herein.

Prompt 200 may be intended to elicit an output from a generative AI model (e.g., of generative AI models 202) that includes information content desired by downstream consumer 106A (e.g., prompt 200 may be obtained from downstream consumer 106A, refer to FIG. 1 for details regarding downstream consumer 106A). Prompt 200, for example, may include human-interpretable text and may include a question. For example, prompt 200 may include: (i) a request from a user for help assessing a malfunction of a computer system, (ii) a request from a customer for a product recommendation, (iii) a request from an employee of a business for a recommendation regarding a financial product (e.g., whether to extend a line of credit to a customer), and/or (iv) other requests. Refer to FIG. 2F for an example of prompt 200.

Data sources 201 may include identifiers and/or other information corresponding to data sources 108 described in FIG. 1. For example, data sources 201 may include a lookup table and keywords may be used to perform lookup processes in the lookup table to retrieve information regarding data sources relevant to the keywords. The keywords may include any type of information (e.g., a geographical location of a data source, an age of a data source, a type of information content of a data source).

Data source filtering process 204 may include: (i) obtaining, based on prompt 200 and relevance criteria, a set of data sources that includes information content relevant to prompt 200, (ii) performing, using a data source equivalence schema and the relevant data sources, a set of clusters based on affiliations of the relevant data sources, (iii) generating, using a second generative AI model of generative AI models 202 and prompt 200, a set of questions intended to elicit answers that have a pre-determined level of complexity (e.g., a one-term answer, an answer selected from a finite list of possible answers), (iv) obtaining, using the set of the questions and the clusters, a set of answers to the set of the questions (e.g., each cluster of the clusters may contribute one answer to each question of the set of the questions), (v) identifying, using at least a consensus threshold and the set of the answers, sub-set of data sources 206, and/or (vi) other methods. Sub-set of data sources 206 may include data sources that provided answers that met the consensus threshold. Refer to FIGS. 2B-2C for additional details regarding performing data source filtering process 204.

Sub-set of data sources 206, therefore, may include identifiers for one or more data sources of data sources 201. The data source identifiers included in sub-set of data sources 206 may correspond to data sources that include information content that is: (i) relevant to prompt 200 (e.g., based on relevancy criteria, refer to FIG. 2B), and (ii) has an inter-data source consistency considered acceptable (e.g., based on a consensus threshold, refer to FIG. 2C). Therefore, sub-set of data sources 206 may have an increased likelihood of including relevant, up-to-date, and reliable information when compared to other data sources of data sources 201.

Prompt 200 and sub-set of data sources 206 may be used to perform retrieval-augmented generation (RAG) process 208 to obtain perturbated sets of data sources 210 and plurality of outputs 212. During RAG process 208, members of sub-set of data sources 206 may be iteratively perturbated to obtain perturbated sets of data sources 210. Each perturbated set of data sources of perturbated sets of data sources 210 may be used to generate an ingest data package (not shown) for a first generative AI model of generative AI models 202. Each ingest data package, therefore, may include: (i) prompt 200, and (ii) a portion of sub-set of data sources 206.

Iteratively modifying the members of sub-set of data sources 206 may include: (i) removing a member (e.g., a data source) of data sources 206, (ii) replacing the member of data sources 206 with a replacement data source (e.g., obtained using a policy, obtained from a downstream consumer, obtained from a subject matter expert (SME)), and/or (iii) other actions.

The member may be selected: (i) randomly, (ii) based on a policy, (iii) based on a data source replacement schema, (iv) based on user feedback (e.g., a client may select the member via a GUI), and/or (v) via other methods.

Generating an ingest data package, therefore, may include: (i) obtaining the prompt and data chunks from a first perturbated set of data sources of perturbated sets of data sources 210, (ii) feeding the data chunks and/or information related to the first perturbated set of data sources into a re-ranking model (e.g., bidirectional encoder representations from transformers (BERT)-based models, learning to rank models) to obtain a prioritized list of the data chunks and/or data sources, (iii) adding (e.g., using a schema for adding data to ingest data packages) the prioritized list and the prompt to the ingest data package, and/or (iv) other methods.

The schema for adding the data to the ingest data packages may include, for example, a set of questions (e.g., to be answered by a subject matter expert, to be answered automatically via one or more application programming interfaces (APIs)). The set of the questions may include: “What data sources are to be added to the ingest data package?” Data sources of the prioritized list of the data sources may be provided in response and, consequently, may be added to the ingest data package.

During RAG process 208, therefore, prompt 200 may be evaluated using the first generative AI model using perturbated sets of data sources 210 as context for prompt 200 to obtain plurality of outputs 212. For example, each ingest data package (e.g., based on prompt 200 and one of perturbated sets of data sources 210) may be fed into the first generative AI model as ingest. Plurality of outputs 212, therefore, may include one output corresponding to each ingest data package.

Information content of plurality of outputs 212 may vary based on contextual information available to the first generative AI model during each instance of output generation via a RAG process. Refer to FIGS. 2F-2I for an example of prompt 200 and two outputs of plurality of outputs 212 based on different perturbated sets of data sources.

At least perturbated sets of data sources 210 and plurality of outputs 212 may be used to perform RAG explainability report generation process 214 to obtain RAG explainability report 216. Performing RAG explainability report generation process 214 may include: (i) obtaining, using a first output of plurality of the outputs 212 and a second output of plurality of the outputs 212, first information elements of the first output and second information elements of the second output, (ii) comparing the first information elements and the second information elements to obtain a difference, (iii) populating, based on the difference, RAG explainability report 216 with at least a first relationship of the relationships.

The first information elements and the second information elements may include any item, object, or entity in the first output and the second output respectively. The first and second information elements may be identified via any algorithm, machine learning model, and/or rule set for natural language processing to extract information from text. Information elements may be extracted from other types of data modalities (e.g., images, audio, video) via object recognition algorithms or models. Information elements may be obtained via other methods without departing from embodiments disclosed herein.

For example, prompt 200 may include the following text: “My computer is not working. It keeps re-starting and overheating. I have computer A and I use operating system B, monitor C, keyboard D, and mouse E. How do I fix it?” The first output may include the following text: “We recommend re-installing driver F and disconnecting and re-connecting all Bluetooth devices.”

The first information elements (e.g., of the first output), therefore, may include: (i) “re-install,” (ii) “driver F,” (iii) “disconnect and re-connect,” and (iv) “Bluetooth devices.”

The first information elements may be stored as a list (e.g., of graph data structures), as a graphical representation of the first information elements (e.g., a visualization of the graph data structures), as human-interpretable text that summarizes the first information elements, and/or in other formats. Refer to FIG. 2H for an example graphical representation of the first output. The first information elements (e.g., the human-interpretable text, the graphical representation, the list) may be published to a client portal and may be accessible by a downstream consumer via a graphical user interface (GUI).

First graph data structures of the first information elements may include: (i) first nodes that correspond to the first information elements, and (ii) first edges that represent relationships between the first nodes. The first graph data structures may be used to generate a first graphical representation of the first output, and the first graphical representation may be viewable by a downstream consumer via a GUI. The downstream consumer may also interact with the first graphical representation (e.g., may select nodes to view additional descriptive information, may provide feedback related to removal, replacement, and/or requests for explainability information for any of the first set of the nodes. Second graph data structures of the second information elements may include: (i) second nodes that correspond to the second information elements, and (ii) second edges that represent relationships between the second nodes. The second graph data structures may be used to generate a second graphical representation of the second output, and the second graphical representation may also be viewable by a downstream consumer via the GUI.

The second information elements may be obtained via similar methods as those described above with respect to the first information elements. Therefore, information elements of each of plurality of outputs 212 may be obtained as part of RAG explainability process.

The difference (e.g., between the first information elements and the second information elements) may be obtained via any data comparison tool, algorithm, and/or model trained to compare text and/or graphs. For example, the second information elements (e.g., displayed as human-interpretable text, displayed as a graphical representation) may be compared to the first information elements (e.g., displayed as human-interpretable text, displayed as a graphical representation) to identify any of the second information elements that are not included in the first information elements.

Therefore, comparing the first information elements and the second information elements may include comparing the first graph data structures (e.g., the first nodes) to the second graph data structures (e.g., the second nodes) to identify any of the second nodes, for example, that do not appear in the first graphical representation.

The difference may be used to establish a first relationship of the relationships included in RAG explainability report 216. The first relationship may indicate a correlation between a first member of sub-set of data sources 206 (e.g., a first data source) and the difference (e.g., the portion of the first output that differs from the second output).

The processes described with respect to the first output and the second output may be repeated any number of times with different pairs of outputs selected from plurality of outputs 212 and any number of relationships may, therefore, be generated and added to RAG explainability report 216.

RAG explainability report 216 may include human-interpretable text indicating the relationships between the members of sub-set of data sources 206 and information elements of plurality of outputs 212. RAG explainability report 216 may be intended to explain, to downstream consumer 106A, why the first generative AI model of generative AI models 202 generated the information content of plurality of outputs 212 (e.g., an impact of a presence of absence of different data sources as context for prompt 200 on various decisions by the first generative AI model).

Thus, by implementing the data flow shown in FIG. 2A, a system in accordance with embodiments disclosed herein may be used to generate: (i) outputs from generative AI models based on prompts and data sources used to obtain contextual information and (ii) RAG explainability reports for the outputs. By iteratively modifying sets of data sources used as context for prompt 200 during output generation, relationships between data sources and information elements of outputs may be established. Consequently, the relationships may be included in the RAG explainability report and the RAG explainability report may be used to understand why the output was generated by the generative AI model thereby increasing a reliability and/or usefulness of the output to the downstream consumer.

Turning to FIG. 2B, a second data flow diagram in accordance with an embodiment is shown. The second data flow diagram may illustrate data used in and data processing performed during at least a partial expansion of data source filtering process 204 described in FIG. 2A.

During data source filtering process 204, at least relevant data source identification process 222 and clustering process 226 may be performed. During relevant data source identification process 222, data sources 201, prompt 200, and relevancy criteria 220 may be used to obtain relevant data sources 224.

Refer to the description of FIG. 2A for additional details regarding prompt 200 and data sources 201. Relevancy criteria 220 may include any thresholds, rule sets, schemas, algorithms, and/or other information usable to guide selection of relevant data sources 224 from data sources 201. To meet relevancy criteria 220, for example, information content of data sources of data sources 201 may: (i) be generated within a duration of time (e.g., the past year), (ii) match (e.g., to an extent considered acceptable) one or more keywords extracted from prompt 200, and/or (iii) meet other criteria (e.g., be compliant with a data privacy regulation).

Relevant data sources 224, therefore, may meet relevancy criteria 220 and may include a portion of the data sources listed in data sources 201. Relevant data sources 224 may include, for example, identifiers for the portion of the data sources.

Relevant data sources 224 and data source equivalence schema 228 may be used to perform clustering process 226 to obtain clusters 230. Data source equivalence schema 228 may include a policy, rule set, and/or other instructions for assigning data sources of relevant data sources 224 to clusters of clusters 230. Data source equivalence schema 228 may be obtained from a downstream consumer, from a subject matter expert (SME), may be generated based on downstream consumer feedback, and/or may be obtained from another entity. Data source equivalence schema 228, for example, may indicate that an affiliation is to be obtained for each data source of relevant data sources 224 and that data sources with a same affiliation are to be grouped to generate a cluster of clusters 230. Therefore, each cluster of clusters 230 may be associated with one affiliation.

Obtaining the affiliations may include analyzing: (i) information content of the data sources, (ii) metadata for the data sources (e.g., contributors, sponsors, visual components). For example, a first data source may include a logo associated with a company (e.g., identified using an object recognition algorithm) and, therefore, the first data source may be considered affiliated with the company.

Any clustering algorithm (e.g., K-means clustering using embeddings for metadata related to the affiliations, hierarchical clustering using a scheme, density-based spatial clustering of applications with noise (DBSCAN) using the embeddings for metadata related to the affiliations) may be used to generate clusters 230. Refer to FIG. 2D for an example of a set of clusters of data sources.

Turning to FIG. 2C, a third data flow diagram in accordance with an embodiment is shown. The third data flow diagram may illustrate data used in and data processing performed during at least a partial expansion of data source filtering process 204 described in FIG. 2A.

Prompt 200, and generative AI model 202A may be used to perform question generation process 232 to obtain set of questions 234. Generative AI model 202A may be similar to any of the generative AI models included in generative AI models 202 described in FIG. 2A. During question generation process 232, a second prompt may be generated, the second prompt being intended to elicit a response from generative AI model 202A.

The second prompt may include a request for generation of any number of questions and may include various constraints for the questions. For example, the second prompt may indicate: (i) that ten questions are to be generated based on information content of prompt 200 and/or information content of clusters 230 (e.g., using keywords, information elements of prompt 200, and/or other information indicating types of information content present in prompt 200 and/or relevant data sources 224 that make up clusters 230), and (ii) that the questions be intended to elicit answers with a pre-determined level of complexity. The pre-determined level of complexity, for example, may be a one-term answer (e.g., a one-word answer such as yes or no), may be an answer selected from a discretized list of possible answers (e.g., months of the year), and/or may include other constraints.

The second prompt may be used to generate an ingest data package for generative AI model 202A. Generative AI model 202A, therefore, may generate set of questions 234 in response to the ingest data package.

Set of questions 234 and clusters 230 may be used to perform answer generation process 236 to obtain set of answers 238. During answer generation process 236, answers to set of questions 234 may be obtained from each cluster of clusters 230. For example, if clusters 230 includes five clusters and set of questions 234 includes ten questions, set of answers 238 may include five sets of answers to each of the ten questions (e.g., 50 total answers).

For example, a first question of set of questions 234 may include the following text: “During what month does New Years Eve occur in the United States?” Four of the five clusters of clusters 230 may provide the answer “December” and one of the five clusters of clusters 230 may provide the answer “January.”

Set of answers 238 and consensus threshold 242 may be used to perform consensus answer analysis process 240 to obtain sub-set of data sources 206.

During consensus answer analysis process 240, each data source of clusters 230 may provide an answer to each question of set of questions 234. Within each cluster of clusters 230, a consensus answer for each question may be obtained (e.g., by using a majority answer within the cluster as the consensus answer) and used as an answer of set of answers 238. Therefore, each cluster may contribute one set of answers (e.g., intra-cluster consensus answers) to set of answers 238.

During consensus answer analysis process 240, set of answers 238 obtained from clusters 230 may be compared to consensus threshold 242. Consensus threshold 242, for example, may include instructions for obtaining inter-cluster consensus answers to each question of set of questions 234. Consensus threshold 242 may indicate that any answer to a question that appears in at least 50% of the answers to the question is to be used as the consensus answer to the question.

Continuing with the above example, the first question may include the following text: “During what month does New Years Eve occur in the United States?” Four of the five clusters of clusters 230 may provide the answer “December” as their consensus answers and one of the five clusters of clusters 230 may provide the answer “January” as its consensus answer.

Therefore, 80% of the answers (e.g., included in set of answers 238) to the first question may include the text “December” and 20% of the answers may include the text “January.” As the answer including the text “December” meets consensus threshold 242, the human-interpretable text “December” may be considered the consensus answer (e.g., the inter-cluster consensus answer) to the first question.

During consensus answer analysis process 240, data sources of clusters that do not provide the consensus answers to set of questions 234 may be rejected for inclusion in sub-set of data sources 206. To be included in sub-set of data sources 206, for example, a data source may be required to provide the consensus answer to every question of set of questions 234. Data sources may be required to provide another amount of the consensus answers (e.g., at least 90% of the consensus answers to set of questions 234) without departing from embodiments disclosed herein.

Entities (e.g., of a particular affiliation) may attempt to influence RAG processes by generating a large number of data sources that support the particular affiliation. Therefore, the consensus answer to a question may appear to be an answer provided by the data sources associated with the affiliation (e.g., due to a majority of the data sources providing a particular answer). Therefore, by obtaining one answer to each of set of questions 234 from each cluster rather than from each data source, an influence of the particular affiliation may be reduced.

Therefore, sub-set of data sources 206 may include: (i) all of relevant data sources 224 or (ii) a portion of relevant data sources 224. Data sources approved for inclusion in sub-set of data sources 206 may: (i) be considered relevant to prompt 200 (e.g., based on at least relevancy criteria 220, and (ii) have a degree of inter-data source consistency that is considered acceptable (e.g., based on at least consensus threshold 242).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning to FIG. 2D, an example of a set of clusters of data sources is shown. Seventeen data sources (e.g., 108A-108Q) and seven clusters (e.g., 250, 251, 252, 253, 254, 256, and 258) are shown. For example, based on an analysis of the seventeen data sources, data sources 108A, 108E, 108F, 108I, and 108L may be found to have a first affiliation (e.g., a first company) and may be grouped to generate cluster 250. Data sources 108G, 108J, and 108K may be found to have a second affiliation (e.g., a first political party) and may be grouped to generate cluster 258. Data sources 108C, 108H, 108M, 108N, and 108O may be found to have a third affiliation (e.g., a second company) and may be grouped to generate cluster 256. Data source 108B may be found to have a fourth affiliation (e.g., a first government entity) and may be assigned its own cluster (e.g., cluster 254). Data source 108D may be found to have a fifth affiliation (e.g., no affiliation) and may be assigned its own cluster (e.g., cluster 252). Data source 108P may be found to have a sixth affiliation and may be assigned its own cluster (e.g., cluster 251) and data source 108Q may be found to have a seventh affiliation and may be assigned its own cluster (e.g., cluster 253).

Turning to FIG. 2E, an example of accepting or rejecting data sources 108A-108Q (e.g., shown in FIG. 2D) for inclusion in sub-set of data sources 206 (e.g., described in FIG. 2A) is shown.

For example, each cluster shown in FIG. 2D may contribute one consensus answer to each question of set of questions 234 (e.g., shown in FIG. 2C). A first question of set of questions 234 may include the text: “During what month is New Years Eve in the United States?” Data source 108A may answer “January,” data source 108E may answer “January,” data source 108F may answer “January,” data source 108I may answer “January,” and data source 108L may answer “December.” Therefore, cluster 250 may have a first consensus answer of “January,” as a majority of the data sources of cluster 250 contributed the answer “January” to the first question.

The other consensus answers shown in cluster consensus answers 260 may be obtained using methods similar to those described above with respect to cluster 250. Cluster consensus answers 260, therefore, may include a first column listing the identifiers for the clusters shown in FIG. 2D (e.g., cluster 250, cluster 252, cluster 254) and a second column listing consensus answers for each of the clusters to the first question.

Consensus answer 262 may include information content provided by a quantity of the clusters that meets consensus threshold 242 (e.g., a majority, 75% of the clusters). Five out of the seven clusters may contribute the answer “December” and, therefore, consensus answer 262 may include the answer “December.”

Data source status 264 may include a list of data sources that may be accepted for inclusion in sub-set of data sources 206 and a list of data sources that may be rejected for inclusion in sub-set of data sources 206. For example, any data sources that did not contribute consensus answer 262 may be rejected and any data sources that did contribute the consensus answer may be accepted. As cluster 250 and cluster 256 contributed the answer “January,” the data sources associated with cluster 250 and cluster 256 (e.g., data sources 108A, 108E, 108F, 108I, 108L, 108C, 108H, 108M, 108N, and 108O) may be rejected for inclusion in sub-set of data sources 206.

Returning to FIG. 2E, clusters 250 and 256 are shown with the highest number of data sources (e.g., each have five data sources). Therefore, without generating the clusters as shown in FIG. 2D, a majority of the data sources may have provided an answer of “January” and “January” may have been erroneously used as the consensus answer.

Turning to FIG. 2F, an example of prompt 200, output 267 (e.g., one of plurality of outputs 212 described in FIG. 2A), and RAG explainability report 216 are shown. A customer (e.g., downstream consumer 106A described in FIG. 2A) may access graphical user interface (GUI) 265 through which the customer may receive assistance troubleshooting hardware components purchased from a vendor and/or manufacturer of the hardware components. A customer may open chat window 266 as part of functionality of GUI 265 and may enter prompt 200 into the chat window. Prompt 200 may include the following text: “My computer is not working. It keeps re-starting and overheating. I have computer A and I use operating system B, monitor C, keyboard D, and mouse E. How do I fix it?” Prompt 200 is shown next to a circle with the letter “Q” inside the circle to indicate a question from the customer that was submitted via chat window 266.

Output 267 may include the following text: “We recommend re-installing driver F and disconnecting and re-connecting all Bluetooth devices.” Output 267 is shown next to a circle with the letter “A” inside the circle to indicate an answer from the manufacturer/vendor for the hardware component (e.g., via the generative AI model).

Output 267 may be visible to the customer via chat window 266. However, the customer may wish to understand why the two steps (e.g., updating driver F and disconnecting and re-connecting all Bluetooth devices) were recommended. Therefore, the customer may utilize a human interface device (e.g., a mouse) to select the button labeled “explain why” located under output 267. By selecting the “explain why” button, RAG explainability report 216 may be displayed as a pop-up window on GUI 265. Prompt 200, output 267, and RAG explainability report 216 may be presented to the customer via other methods (e.g., via another GUI, via another messaging interface) without departing from embodiments disclosed herein.

RAG explainability report 216 may include the following text: “Re-installing driver F was recommended based on data sources 108A, 108D, and 108G. Disconnecting and re-connecting all Bluetooth devices was recommended based on data source 108C.”

Turning to FIG. 2G, an example first graphical representation of prompt 200 is shown (e.g., graphical representation 269) and a list of data sources to be used as context for prompt 200 during a RAG process to obtain an output may be shown (e.g., data sources 268). Graphical representation 269 may be displayed to a downstream consumer (e.g., a client) via a GUI (e.g., GUI 265 described in FIG. 2F). To obtain graphical representation 269, first information elements of prompt 200 may be represented as nodes (e.g., 270-277) with edges between the nodes (e.g., edge 278) to indicate relationships between the first information elements.

For example, the information elements extracted from prompt 200 may include: (i) “computer A” shown as node 271, (ii) “monitor C” shown as node 270, (iii) “re-starting” shown as node 277, (iv) “keyboard D” shown as node 273, (v) “overheating” shown as node 275, (vi) “mouse E” shown as node 274, (vii) “not working” shown as node 276, and (viii) “operating system B” shown as node 272.

The edges between the nodes (e.g., 278) may represent relationships (e.g., data dependencies, data flows, entities that cooperatively perform workloads). For example, edge 278 may connect node 270 and node 271 to indicate that computer A receives data (e.g., input from a user) from monitor C.

Descriptive information may be embedded in the nodes as internal representations (not shown). For example, information regarding computer A (e.g., specifications, hardware components, firmware versions, software installed) may be included in an internal representation of node 271. The internal representation may be shown, for example, if a user selects node 271 via a GUI.

Turning to FIG. 2H, the example of output 267, graphical representation 279, and data sources 268 are shown. Output 267 may be generated by a generative AI model (e.g., generative AI model 202A described in FIG. 2B) using prompt 200 and data sources 268 as context for prompt 200 (e.g., a RAG process). Graphical representation 279 may include four nodes (e.g., 280, 281, 282, 283) that correspond to information elements of output 267. For example, the information elements of output 267 may include: (i) “re-install” shown as node 281, (ii) “disconnect and re-connect” shown as node 282, (iii) “driver F” shown as node 280, and (iv) “Bluetooth devices” shown as node 283. Edge 284 may represent a relationship between node 280 and node 281 (e.g., indicating that the re-installation is to be performed for driver F).

Turning to FIG. 2I, an example of output 286, data sources 285, and graphical representation 287 are shown. Output 286 may be generated by a generative AI model (e.g., generative AI model 202A described in FIG. 2B) using prompt 200 and data sources 285 as context for prompt 200. Data sources 285 may be a perturbation of data sources 268 shown in FIG. 2H (e.g., data source 108C may be removed from data sources 268 to obtain data sources 285.

Graphical representation 287 may represent information elements of output 286. Node 280 and node 281 may be grayed out in graphical representation 287 to indicate that node 280 and node 281 do not appear in graphical representation 287. Output 286, therefore, may include the text: “We recommend disconnecting and re-connecting all Bluetooth devices.”

Consequently, during a RAG explainability process, graphical representation 279 (e.g., shown in FIG. 2H) of output 267 may be compared to graphical representation 287 (e.g., shown in FIG. 2I) of output 286 to obtain a difference. The difference may indicate that nodes 280 and 281 are not present in graphical representation 287. The difference may, therefore, be used to establish a first relationship between data source 108C and “driver F.” The first relationship may be added to RAG explainability report 216.

Thus, the example shown in FIGS. 2F-2I may represent a first instance of data source removal to modify a sub-set of data sources used to provide context for a generative AI model prompt. However, data sources may also be replaced with replacement data sources at any time during a RAG explainability process and/or after completion of a first RAG explainability process.

As discussed above, the components of FIG. 1 may perform various methods to manage a data processing system. FIGS. 3A-3C illustrate methods that may be performed by the components of the system of FIG. 1. In the diagram discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method of providing computer-implemented services using generative AI models in accordance with an embodiment is shown. The method may be performed, for example, by any of the components of the system of FIG. 1, and/or other components not shown therein.

At operation 300, a prompt may be obtained for a first generative AI model of generative AI models. Obtaining the prompt for the first generative AI model may include: (i) reading the prompt from storage, (ii) receiving (e.g., via a communication system) the prompt from another entity, (iii) receiving the prompt as part of user feedback submitted via a GUI (e.g., a chat interface displayed on the user's device), and/or (iv) other methods.

At operation 302, a data source filtering process may be performed using at least the prompt, the first generative AI model, and data sources to obtain a sub-set of the data sources. Performing the data source filtering process may include: (i) obtaining, based on the prompt, relevance criteria, and a data source equivalence schema, clusters, (ii) generating, using a second generative AI model and the prompt, a set of questions intended to elicit answers with a pre-determined level of complexity, (iii) obtaining, using the set of the questions and the clusters, a set of answers to the set of the questions, (iv) identifying, using at least the consensus threshold and the set of the answers, the sub-set of the data sources, and/or (v) other methods. Refer to FIG. 3B for additional details regarding performing the data source filtering process.

At operation 304, a RAG explainability process may be performed using at least the prompt, the first generative AI model, and the sub-set of the data sources to obtain: (i) a plurality of outputs based on the prompt and perturbations of members of the sub-set of the data sources, and (ii) a RAG explainability report indicating relationships between the members of the sub-set of the data sources and information elements of the plurality of the outputs.

Performing the RAG explainability process may include: (i) iteratively perturbating members of the sub-set of the data sources to obtain perturbated sets of the data sources, (ii) evaluating the prompt using the first generative AI model and the perturbated sets of the data sources as context for the prompt to obtain perturbated outputs as the plurality of the outputs, (iii) obtaining, using a first output of the plurality of the outputs and a second output of the plurality of the outputs, first information elements of the first output and second information elements of the second output, (iv) comparing the information elements and the second information elements to obtain a difference, (v) populating, based on the difference, the RAG explainability report with at least the first relationship of the relationships, and/or (vi) other methods. Refer to FIG. 3C for additional details regarding performing the RAG explainability process.

At operation 306, computer-implemented services may be provided to a downstream consumer using at least the plurality of the outputs and the RAG explainability report. Providing the computer-implemented services to the downstream consumer may include: (i) populating a GUI with at least the plurality of the outputs and the RAG explainability report to obtain a populated GUI, (ii) making decisions based on at least the plurality of the outputs, (iii) providing the plurality of the outputs, the RAG explainability report, and/or other information to another entity (e.g., the downstream consumer), and/or (iv) other methods.

Populating the GUI with at least the plurality of the outputs and the RAG explainability report may include: (i) uploading, via an application programming interface (API), the plurality of the outputs and the RAG explainability report to the GUI, (ii) providing the plurality of the outputs and the RAG explainability report to another entity responsible for uploading the plurality of the outputs and the RAG explainability report to the GUI, and/or (iii) other methods.

The method may end following operation 306.

Turning to FIG. 3B, a second flow diagram illustrating a method of providing computer-implemented services using generative AI models in accordance with an embodiment is shown. The method may be performed, for example, by any of the components of the system of FIG. 1, and/or other components not shown therein. The method shown in FIG. 3B may be at least a partial expansion of operation 302 shown in FIG. 3A.

At operation 310, the clusters may be obtained based on the prompt, relevance criteria, and the data source equivalence schema. Obtaining the clusters may include: (i) obtaining, based on the prompt and the relevance criteria, a set of the data sources that includes information content relevant to the prompt, (ii) obtaining, based on the data source equivalence schema and the set of the data sources, affiliations for the set of the data sources, (iii) performing, based on the affiliations and the data source equivalence schema, a clustering process to obtain the clusters, each cluster of the clusters being associated with an affiliation of the affiliations, and/or (iv) other methods.

The relevance criteria may be obtained by: (i) reading the relevance criteria from storage, (ii) receiving the relevance criteria from another entity (e.g., a subject matter expert, the downstream consumer), (iii) generating the relevance criteria (e.g., based on feedback from the downstream consumer, based on feedback from a subject matter expert), and/or (iv) other methods.

Obtaining the set of the data sources that includes the information content relevant to the prompt may include performing a relevancy search based on the relevance criteria and the data sources. Performing the relevancy search may include: (i) parsing the prompt to obtain information elements of the prompt, (ii) matching the information elements to portions of information content of the data sources (e.g., via vector representations of the information elements and the information content of the data sources), and/or (iii) other methods.

Obtaining the affiliations for the set of the data sources may include: (i) reading the affiliations from storage, (ii) receiving the affiliations from another entity (e.g., via a communication system), (iii) generating the affiliations (e.g., using natural language processing, object recognition, another inference model), and/or (iv) other methods.

Performing the clustering process may include: (i) executing, based on constraints specified by the data source equivalence schema, a clustering algorithm (e.g., K-means clustering, density-based special clustering of applications with noise (DBSCAN), hierarchical clustering) to generate the clusters, (ii) providing the data source equivalence schema and the affiliations to another entity responsible for executing the clustering algorithm, and/or (iii) other methods. Refer to FIG. 2D for an example of clusters of data sources based on affiliations.

At operation 312, a set of questions intended to elicit answers with a pre-determined level of complexity may be generated using a second generative AI model and the prompt. Generating the set of the questions may include generating an ingest data package for the second generative AI model. The ingest data package may include: (i) a second prompt, the second prompt indicating that a set of questions is to be generated, (ii) constraints for generation of the second prompt (e.g., a number of questions to be generated, a pre-determined level of complexity of answers intended to be elicited by the set of the questions), (iii) an indication that the set of the data sources are to be used as context for the second prompt, and/or (iv) other information.

Generating the set of the questions may also include feeding the ingest data package into the second generative AI model to obtain the set of the questions as output from the second generative AI model and/or other methods.

At operation 314, a set of answers to the set of the questions may be obtained using the set of the questions and the clusters. Obtaining the set of the answers may include, for each cluster of the clusters and based on the information content of the data sources, obtaining a consensus answer to each question of the set of the questions to obtain a set of consensus answers, and using the set of the consensus answers as the set of the answers.

Obtaining the set of the consensus answers may include: (i) obtaining an answer from each of the data sources included in the clusters, (ii) for each cluster, obtaining intra-cluster consensus answers to each question based on answers provided by members of the clusters (e.g., a majority answer within the cluster), and/or (iii) other methods.

Obtaining the answer from each of the data sources may include: (i) retrieving information content relevant to the prompt from a first data source (e.g., reading the information content from storage, performing a lookup process, providing a request to the data source for the information content relevant to the prompt), (ii) using the information content relevant to the prompt to generate (e.g., via a large language model, via another model and/or rule set for answer generation) human-interpretable text representing answers to the questions, and/or (iii) other methods. Generating the set of the answers may include performing the above methods for each other data source of the set of the data sources.

Using the set of the consensus answers as the set of the answers may include: (i) generating a data structure that includes the set of the consensus answers, (ii) labeling the data structure as the set of the answers, (iii) providing the set of the consensus answers to another entity and indicating (to the entity) that the set of the consensus answers are to be used as the set of the answers, and/or (iv) other methods.

At operation 316, the sub-set of the data sources may be identified using at least a consensus threshold and the set of the answers. The sub-set of the data sources may correspond to answers of the set of the answers that meet the consensus threshold. Identifying the sub-set of the data sources may include: (i) identifying, using the set of the answers, a frequency for each answer of the set of the answers to obtain a set of frequencies, (ii) selecting, based on the set of the frequencies and the consensus threshold, at least one answer of the set of the answers that meets the consensus threshold, (iii) rejecting data sources of the set of the data sources that provided answers to the set of the questions that do not match the at last one answer for inclusion in the sub-set of the data sources, and/or (iv) other methods.

Identifying the frequency for each answer of the set of the answers may include: (i) aggregating unique answers of the set of the answers (e.g., a list that excludes duplicate answers) to obtain a list of unique answers to each question of the set of the questions, (ii) counting a number of instances of each of the unique answers in the set of the answers to obtain the frequency for each answer of the set of the answers, (iii) providing the set of the answers to another entity responsible for generating the frequency for each answer of the set of the answers, (iv) feeding the set of the answers into a model and/or algorithm to count instances of unique answers of the set of the answers, and/or (v) other methods.

For example, the set of the questions may include ten questions and the clusters may include five clusters. A first question of the set of the questions may be intended to elicit a “yes” or “no” answer. The answers obtained from the five clusters may include two unique answers (e.g., yes and no). The number of instances of “yes” in the answers may be four and the number of instances of “no” in the answers may be one. Therefore, the frequency of the first unique answer (e.g., “yes”) may be represented as: (i) “4,” (ii) “80%,” and/or (iii) other representations without departing from embodiments disclosed herein.

Selecting the at least one consensus answer may include: (i) comparing the frequencies associated with each unique answer to a first question to a quantification of the consensus threshold to identify one or more of the unique answers to the first question that meets the consensus threshold, (ii) using the one or more unique answers to the first question that meets the consensus threshold as the consensus answer for the first question, and/or (iii) other methods. The method described for selecting the at least one consensus answer may be repeated for each question of the set of the questions to obtain a set of consensus answers.

Continuing with the above example, the unique answer “yes” may have a frequency of 80%. The consensus threshold may indicate that any unique answer with a frequency of at least 50% may meet the consensus threshold. Therefore, the unique answer “yes” may be used as the consensus answer for the first question.

Rejecting the data sources of the set of the data sources that provided the answers to the set of the questions that do not match the at least one consensus answer for inclusion in the sub-set of the data sources may include: (i) populating a list of identifiers of the sub-set of the data sources with identifiers for clusters that provided the consensus answer to each question of the set of the questions, (ii) not populating the list of the identifiers of the sub-set of the data sources with identifiers for data sources that are members of clusters that did not provide the consensus answer to each question of the set of the questions, (iii) providing the set of the clusters and the frequencies for the set of the answers to another entity, and/or (iv) other methods.

Data sources may be rejected based on other criteria (e.g., data sources may be required to have provided the consensus answer to at least 90% of the set of the questions) without departing from embodiments disclosed herein.

Identifying the sub-set of the data sources may also include determining, using the prompt, the data sources, and a re-ranking model, whether any of the data sources that provided answers that did not match the consensus answer are highly ranked (e.g., based on a threshold for rankings considered “highly ranked”) with respect to the prompt. To do so, the set of the data sources considered relevant to the prompt may be ranked (e.g., using the re-ranking model) to obtain a ranking. If, for example, a data source that did not provide the consensus answer is ranked highly in the ranking, the one or more data sources may be retained in the sub-set of the data sources. Therefore, a ranking for a data source (e.g., indicating a relevance to the prompt) and whether the data source provided the consensus answer may both contribute to whether the data source is rejected from inclusion in the sub-set of the data sources (e.g., a schema may indicate a first weighting for rankings and a second weighting for consensus answers to be used to determine whether to reject the data source). Doing so may increase a likelihood that outputs generated using the sub-set of the data sources meets needs of the downstream consumer.

The method may end following operation 316.

Turning to FIG. 3C, a third flow diagram illustrating a method of providing computer-implemented services using generative AI models in accordance with an embodiment is shown. The method may be performed, for example, by any of the components of the system of FIG. 1, and/or other components not shown therein. The method shown in FIG. 3C may be an expansion of operation 304 shown in FIG. 3A.

At operation 320, members of the sub-set of the data sources may be iteratively perturbated to obtain perturbated sets of the data sources. Iteratively perturbating the members of the sub-set of the data sources may include at least one action selected from a list of actions consisting of: (i) removing a first data source of the sub-set of the data sources to obtain a first perturbated set of the perturbated sets of the data sources, and (ii) replacing the first data source with a replacement data source to obtain the first perturbated set of the perturbated sets of the data sources. Iteratively perturbating the information content of the prompt may include any number of perturbations to obtain any number of perturbated sets of data sources.

Removing the first data source may include: (i) selecting the first data source (e.g., randomly, based on a schema, based on feedback from a downstream consumer, based on feedback from a subject matter expert), (ii) deleting an identifier for the first data source from a list of identifiers of the sub-set of the data sources, (iii) using a model (e.g., a second generative AI model) to create the first perturbated set of data sources, and/or (iv) other methods.

Replacing the first data source with the replacement data source may include: (i) deleting the identifier for the first data source from the list of the identifiers for the sub-set of the data sources, (ii) adding an identifier for the replacement data source to the list of the identifiers for the sub-set of the data sources, (iii) providing the list of identifiers for the sub-set of the data sources and the identifier for the replacement data source to another entity responsible for replacing the first data source, and/or (iv) other methods.

If the at least one action performed as part of iteratively perturbating the members of the sub-set of the data sources, the replacement data source may be obtained prior to replacing the first data source. The replacement data source may be obtained based on the first data source and a data source replacement schema.

Obtaining the replacement data source may include: (i) obtaining the data source replacement schema (e.g., from storage, from another entity via a communication system, from a downstream consumer via a GUI), (ii) reading instructions from the data source replacement schema (e.g., for selecting the first data source, for obtaining the replacement data source), (iii) selecting, based on the data source replacement schema, the first data source (e.g., randomly, based on a hierarchy for preferential selection of different types of data sources), (iv) performing a search process (e.g., a lookup process, a RAG process) using the first data source to obtain one or more replacement data sources (e.g., from a database, from another entity, from any number of other data sources), and/or (v) other methods.

At operation 322, the prompt may be evaluated using the first generative AI model and the perturbated sets of the data sources as context for the prompt to obtain perturbated outputs as the plurality of the outputs. Evaluating the prompt using the first generative AI model to obtain the plurality of outputs may include: (i) obtaining the prompt and the perturbated sets of the data sources, (ii) generating, using the prompt and the perturbated sets of the data sources, a set of ingest data packages, (iii) feeding each ingest data package of the set of the ingest data packages into the first generative AI model to obtain the plurality of the outputs, (iv) providing the prompt and the plurality of the outputs to another entity responsible for operating the first generative AI model, and/or (v) other methods.

Generating the set of the ingest data packages may include: (i) obtaining a first perturbated set of the data sources, (ii) performing a re-ranking process using the first perturbated set of the data sources and a re-ranking model to obtain a ranking for the first perturbated set of the data sources, the ranking being ordered based on relevance of data sources to the prompt, (iii) populating, using a schema (e.g., answering a set of questions) the ingest data package with the first perturbated set of the data sources (e.g., in order based on the ranking), and/or (iv) other methods.

After obtaining the plurality of the outputs, a first graphical representation of a first output of the plurality of the outputs may be added to a graphical user interface (GUI) accessible by a downstream consumer. Adding the first graphical representation may include:
(i) obtaining, based on first information elements of the first output, first graph data structures for the first output, (ii) generating, using the first graph data structures, the first graphical representation, (iii) populating the GUI using at least the first graphical representation to obtain a populated GUI, and/or (iv) other methods.

Obtaining the first graph data structures may include generating, using a generative AI model, an algorithm, and/or another rule set for generating graph data structures: (i) first nodes corresponding to the first information elements, (ii) internal representations for the first nodes including any descriptors and/or supplementary information related to the information elements, and (iii) first edges that represent relationships between the first nodes.

Generating the first graphical representation may include: (i) using a graph generation algorithm to generate a visual representation of at least the first nodes and the first edges, (ii) providing the graph data structures to another entity responsible for generating the first graphical representation, and/or (iii) other methods.

Populating the GUI using at least the first graphical representation may include: (i) uploading the first graphical representation (e.g., via an application programming interface) so that the first graphical representation is available to the user via the GUI, (ii) providing the first graphical representation to another entity responsible for uploading the first graphical representation to the GUI, and/or (iii) other methods.

At operation 324, first information elements of a first output of the plurality of the outputs and second information elements of a second output of the plurality of the outputs may be obtained using the first output and the second output. Obtaining the first information elements and the second information elements may include: (i) utilizing an algorithm, model, and/or rule set to perform natural language processing and/or object recognition to extract the first information elements from the first output and the second information elements from the second output, (ii) providing the first output and the second output to another entity responsible for extracting the first information elements and the second information elements, and/or (iii) other methods.

At operation 326, the first information elements may be compared to the second information elements to obtain a difference. Comparing the first information elements and the second information elements to obtain the difference may include: (i) obtaining first graph data structures of the first output, the first graph data structures including: a first set of nodes that correspond to the first information elements, and first edges that represent relationships between the first set of the nodes, (ii) obtaining second graph data structures of the second output, the second graph data structures including: a second set of nodes that correspond to the second information elements, and second edges that represent relationships between the second set of the nodes, (iii) identifying, using the first graph data structures and the second graph data structures, one or more nodes of the second set of the nodes that is not present in the first set of the nodes, and/or (iv) other methods.

Obtaining the first graph data structures may include: (i) executing a graph data structure generation algorithm or feeding the first information elements into an inference model to obtain the first graph data structures, (ii) performing an analysis process, using the first set of the information elements and supplementary information, to obtain the first edges (e.g., indicating patterns of data flows, data dependencies, workload performance for various entities), and/or (iii) other methods.

Obtaining the second graph data structures may include methods similar to those described above with respect to obtaining the first graph data structures (e.g., with the second information elements in place of the first information elements).

Identifying the one or more nodes of the second set of nodes that is not present in the first graphical representation may include: (i) executing instructions for a comparison algorithm to obtain the difference, the difference indicating that a first information element (e.g., and, therefore a node) is not present in the first graphical representation, (ii) concluding, based on the difference, that the modification to the sub-set of the data sources (e.g., removal and/or replacement of the first data source) is related to the first information element being absent from the first graphical representation, and/or (iii) other methods.

At operation 328, the RAG explainability report may be populated, based on the difference, with at least a first relationship of the relationships. Populating the RAG explainability report with at least the first relationship may include: (i) generating, using a second generative AI model, human-interpretable text summarizing the first relationship, (ii) adding the human-interpretable text summarizing the first relationship to the RAG explainability report, (iii) adding one or more graphical representations (e.g., the first graphical representation, the second graphical representations) to the RAG explainability report, and/or (iv) other methods.

The method may end following operation 328.

Thus, as illustrated above, embodiments disclosed herein may provide systems and methods usable to provide computer-implemented services using generative AI models. By providing a RAG explainability report to a downstream consumer along with an output generated by the generative AI model in response to a prompt, a likelihood of the output meeting needs of the downstream consumer may be increased.

Any of the components illustrated in FIGS. 1-2I may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows^{®}operating system from Microsoft^{®}, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using generative artificial intelligence (AI) models, the method comprising:
obtaining a prompt for a first generative AI model of the generative AI models;
performing, using at least the prompt, the first generative AI model, and data sources, a data source filtering process to obtain a sub-set of the data sources, the sub-set of the data sources being based on:
relevance of information content of the data sources to the prompt, and
inter-data source consistency of the information content of the data sources, the inter-data source consistency being evaluated between clusters of the data sources and the clusters being assigned using a data source equivalence schema so that data sources with a same affiliation are assigned to a same cluster of the clusters;
performing, using at least the prompt, the first generative AI model, and the sub-set of the data sources, a retrieval-augmentation generation (RAG) explainability process to obtain:
a plurality of outputs based on the prompt and perturbations of members of the sub-set of the data sources, and
a RAG explainability report indicating relationships between the members of the sub-set of the data sources and information elements of the plurality of the outputs; and
providing computer-implemented services to a downstream consumer using at least the plurality of the outputs and the RAG explainability report.

2. The method of claim 1, wherein performing the data source filtering process comprises:
obtaining, based on the prompt, relevance criteria, and the data source equivalence schema, the clusters;
generating, using a second generative AI model of the generative AI models and the prompt, a set of questions intended to elicit answers that have a pre-determined level of complexity;
obtaining, using the set of the questions and the clusters, a set of answers to the set of the questions; and
identifying, using at least a consensus threshold and the set of the answers, the sub-set of the data sources, the sub-set of the data sources corresponding to answers of the set of the answers that meet the consensus threshold.

3. The method of claim 2, wherein obtaining the clusters comprises:
obtaining, based on the prompt and the relevance criteria, a set of the data sources that comprises information content relevant to the prompt;
obtaining, based on the data source equivalence schema and the set of the data sources, affiliations for the set of the data sources; and
performing, based on the affiliations and the data source equivalence schema, a clustering process to obtain the clusters, each cluster of the clusters being associated with an affiliation of the affiliations.

4. The method of claim 3, wherein the affiliations comprise at least one type of affiliation selected from a list of types of affiliations consisting of:
a political party affiliation;
a company affiliation;
a government entity affiliation; and
an organization affiliation.

5. The method of claim 2, wherein the pre-determined level of complexity is a one-term answer.

6. The method of claim 2, wherein obtaining the set of the answers comprises:
obtaining, for each cluster of the clusters and based on the information content of the data sources, a consensus answer to each question of the set of the questions to obtain a set of consensus answers; and
using the set of the consensus answers as the set of the answers.

7. The method of claim 2, wherein identifying the sub-set of the data sources comprises:
identifying, using the set of the answers, a frequency for each answer of the set of the answers to obtain a set of frequencies;
selecting, based on the set of the frequencies and the consensus threshold, at least one consensus answer of the set of the answers that meets the consensus threshold; and
rejecting data sources of the set of the data sources that provided answers to the set of the questions that do not match the at least one consensus answer for inclusion in the sub-set of the data sources.

8. The method of claim 1, wherein performing the RAG explainability process comprises:
iteratively perturbating members of the sub-set of the data sources to obtain perturbated sets of the data sources;
evaluating the prompt using the first generative AI model and the perturbated sets of the data sources as context for the prompt to obtain perturbated outputs as the plurality of the outputs;
obtaining, using a first output of the plurality of the outputs and a second output of the plurality of the outputs, first information elements of the first output and second information elements of the second output;
comparing the first information elements and the second information elements to obtain a difference; and
populating, based on the difference, the RAG explainability report with at least a first relationship of the relationships.

9. The method of claim 8, wherein iteratively perturbating the members of the sub-set of the data sources comprises:
performing at least one action selected from a list of actions consisting of:
removing a first data source of the sub-set of the data sources to obtain a first perturbated set of the perturbated sets of the data sources; and
replacing the first data source with a replacement data source to obtain the first perturbated set of the perturbated sets of the data sources.

10. The method of claim 8, wherein comparing the first information elements and the second information elements comprises:
obtaining first graph data structures of the first output, the first graph data structures comprising:
a first set of nodes that correspond to the first information elements, and
first edges that represent relationships between the first set of the nodes;
obtaining second graph data structures of the second output, the second graph data structures comprising:
a second set of nodes that correspond to the second information elements, and
second edges that represent relationships between the second set of the nodes; and
identifying, using the first graph data structures and the second graph data structures, one or more nodes of the second set of the nodes that is not present in the first set of the nodes.

11. The method of claim 10, wherein a first graphical representation based on the first graph data structures and a second graphical representation based on the second graph data structures are displayed to the downstream consumer via a graphical user interface (GUI).

12. The method of claim 1, wherein the first generative AI model is a large language model (LLM).

13. A non-transitory machine-readable medium having instructions stored therein, which when executed by a processor, cause the processor to perform operations for providing computer-implemented services using generative artificial intelligence (AI) models, the operations comprising:
obtaining a prompt for a first generative AI model of the generative AI models;
performing, using at least the prompt, the first generative AI model, and data sources, a data source filtering process to obtain a sub-set of the data sources, the sub-set of the data sources being based on:
relevance of information content of the data sources to the prompt, and
inter-data source consistency of the information content of the data sources, the inter-data source consistency being evaluated between clusters of the data sources and the clusters being assigned using a data source equivalence schema so that data sources with a same affiliation are assigned to a same cluster of the clusters;
performing, using at least the prompt, the first generative AI model, and the sub-set of the data sources, a retrieval-augmentation generation (RAG) explainability process to obtain:
a plurality of outputs based on the prompt and perturbations of members of the sub-set of the data sources, and
a RAG explainability report indicating relationships between the members of the sub-set of the data sources and information elements of the plurality of the outputs; and
providing computer-implemented services to a downstream consumer using at least the plurality of the outputs and the RAG explainability report.

14. The non-transitory machine-readable medium of claim 13, wherein performing the data source filtering process comprises:
obtaining, based on the prompt, relevance criteria, and the data source equivalence schema, the clusters;
generating, using a second generative AI model of the generative AI models and the prompt, a set of questions intended to elicit answers that have a pre-determined level of complexity;
obtaining, using the set of the questions and the clusters, a set of answers to the set of the questions; and
identifying, using at least a consensus threshold and the set of the answers, the sub-set of the data sources, the sub-set of the data sources corresponding to answers of the set of the answers that meet the consensus threshold.

15. The non-transitory machine-readable medium of claim 14, wherein obtaining the clusters comprises:
obtaining, based on the prompt and the relevance criteria, a set of the data sources that comprises information content relevant to the prompt;
obtaining, based on the data source equivalence schema and the set of the data sources, affiliations for the set of the data sources; and
performing, based on the affiliations and the data source equivalence schema, a clustering process to obtain the clusters, each cluster of the clusters being associated with an affiliation of the affiliations.

16. The non-transitory machine-readable medium of claim 15, wherein the affiliations comprise at least one type of affiliation selected from a list of types of affiliations consisting of:
a political party affiliation;
a company affiliation;
a government entity affiliation; and
an organization affiliation.

17. A data processing system, comprising:
a processor; and
a memory coupled to the processor to store instructions, which when executed by the processor, cause the processor to perform operations for providing computer-implemented services using generative artificial intelligence (AI) models, the operations comprising:
obtaining a prompt for a first generative AI model of the generative AI models;
performing, using at least the prompt, the first generative AI model, and data sources, a data source filtering process to obtain a sub-set of the data sources, the sub-set of the data sources being based on:
relevance of information content of the data sources to the prompt, and
inter-data source consistency of the information content of the data sources, the inter-data source consistency being evaluated between clusters of the data sources and the clusters being assigned using a data source equivalence schema so that data sources with a same affiliation are assigned to a same cluster of the clusters;
performing, using at least the prompt, the first generative AI model, and the sub-set of the data sources, a retrieval-augmentation generation (RAG) explainability process to obtain:
a plurality of outputs based on the prompt and perturbations of members of the sub-set of the data sources, and
a RAG explainability report indicating relationships between the members of the sub-set of the data sources and information elements of the plurality of the outputs; and
providing computer-implemented services to a downstream consumer using at least the plurality of the outputs and the RAG explainability report.

18. The data processing system of claim 17, wherein performing the data source filtering process comprises:
obtaining, based on the prompt, relevance criteria, and the data source equivalence schema, the clusters;
generating, using a second generative AI model of the generative AI models and the prompt, a set of questions intended to elicit answers that have a pre-determined level of complexity;
obtaining, using the set of the questions and the clusters, a set of answers to the set of the questions; and
identifying, using at least a consensus threshold and the set of the answers, the sub-set of the data sources, the sub-set of the data sources corresponding to answers of the set of the answers that meet the consensus threshold.

19. The data processing system of claim 18, wherein obtaining the clusters comprises:
obtaining, based on the prompt and the relevance criteria, a set of the data sources that comprises information content relevant to the prompt;
obtaining, based on the data source equivalence schema and the set of the data sources, affiliations for the set of the data sources; and
performing, based on the affiliations and the data source equivalence schema, a clustering process to obtain the clusters, each cluster of the clusters being associated with an affiliation of the affiliations.

20. The data processing system of claim 19, wherein the affiliations comprise at least one type of affiliation selected from a list of types of affiliations consisting of:
a political party affiliation;
a company affiliation;
a government entity affiliation; and
an organization affiliation.
